(19) United States
(12) Patent Application Publication
(10) Pub. No.: US 2007/0267266 A1
(43) Pub. Date: Nov. 22, 2007

(54) TRANSMISSION FOR TRANSMITTING TORQUE SMALLER THAN ADJUSTABLE VALUE

(76) Inventor: Man Lee-Liao, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/383,556

(22) Filed: May 16, 2006

(51) Int. Cl. F16D 7/04

(52) U.S. Cl. 192/56.61; 464/39

(57) ABSTRACT

A transmission for transmitting torque smaller than an adjustable value includes three transmitting elements. The first transmitting element includes a non-circular tunnel and a shoulder. The second transmitting element includes a non-circular insert inserted in the non-circular tunnel, wedges and a shoulder. The third transmitting element includes wedges engaged with the wedges of the second transmitting element. An elastic element is compressed between the shoulders of the first and second transmitting elements so as to engage the wedges of the second transmitting element with the wedges of the third transmitting element. A first collar includes a thread. A second collar includes a thread engaged with the thread of the first collar so that the collars contain the transmitting elements and the elastic element and that the collars can be rotated relative to each other to change the relative axial position between them and adjust the adjustable value.

### BACKGROUND OF INVENTION

1. FIELD OF INVENTION

The present invention relates to a socket wrench including a handle and a socket and, more particularly, to a transmission for transmitting torque smaller than an adjustable value from the handle to the socket of a socket wrench.

2. RELATED PRIOR ART

Disclosed in Taiwanese Patent M289822 is a transmission 10 with controllable torque. The transmission 10 includes a driver (30; 30′; 30″; 30′″), a socket (20; 20′; 20″; 20′″), a wedge element (50; 50′; 50″; 50′″) and a spring (60; 60′; 60″; 60′″). The driver is connected to the socket so that they can be moved and rotated relative to each other. The wedge element is connected to the driver so that they can be moved but not rotated relative to each other. The wedge element can be engaged with and disengaged from the socket. When the wedge element is engaged with the socket, torque can be transmitted between the driver and the socket through the wedge element. The spring is compressed between the driver and the wedge element for engaging the wedge element with the socket. By adjusting the relative axial position between the driver and the socket, the force loaded in the spring is adjusted, and so is the maximum torque that can be transmitted between the wedge element and the socket. However, the relative axial position between the driver and the socket cannot be changed without using a tool. Furthermore, the socket is made of a fixed size so that it cannot be used to drive a fastener of a different size.

The present invention is therefore intended to obviate or at least alleviate the problems encountered in prior art.

### SUMMARY OF INVENTION

According to the present invention, a transmission for transmitting torque smaller than an adjustable value includes three transmitting elements. The first transmitting element includes a non-circular tunnel and a shoulder. The second transmitting element includes a non-circular insert inserted in the non-circular tunnel, wedges and a shoulder. The third transmitting element includes wedges engaged with the wedges of the second transmitting element. An elastic element is compressed between the shoulders of the first and second transmitting elements so as to engage the wedges of the second transmitting element with the wedges of the third transmitting element. A first collar includes a thread. A second collar includes a thread engaged with the thread of the first collar so that the collars contain the transmitting elements and the elastic element and that the collars can be rotated relative to each other to change the relative axial position between them and adjust the adjustable value.

The primary advantage of the transmission of the present invention is that the adjustable value can easily be adjusted by rotating the collars relative to each other.

Other advantages and features of the present invention will become apparent from the following description referring to the drawings.

### BRIEF DESCRIPTION OF DRAWINGS

The present invention will be described through detailed illustration of four embodiments referring to the drawings.

FIG. 1 is a perspective view of a transmission for transmitting torque smaller than an adjustable value according to the first embodiment of the present invention.

FIG. 2 is an exploded view of the transmission shown in FIG. 1.

FIG. 3 is a cross-sectional view of the transmission along a line 3-3 in FIG. 1.

FIG. 4 is a reduced cross-sectional view of the transmission shown in FIG. 3 in an active position.

FIG. 5 is a reduced cross-sectional view of the transmission shown in FIG. 3 in an idle position.

FIG. 6 shows how to adjust the maximum torque that can be transmitted through the transmission shown in FIG. 3.

FIG. 7 is an exploded view of a transmission for transmitting torque smaller than an adjustable value according to the second embodiment of the present invention.

FIG. 8 is a perspective view of a transmission for transmitting torque smaller than an adjustable value according to the third embodiment of the present invention.

FIG. 9 is an exploded view of a transmission for transmitting torque smaller than a set value according to the fourth embodiment of the present invention.

FIG. 10 is a cross-sectional view of the transmission shown in FIG. 9.

### DETAILED DESCRIPTION OF EMBODIMENTS

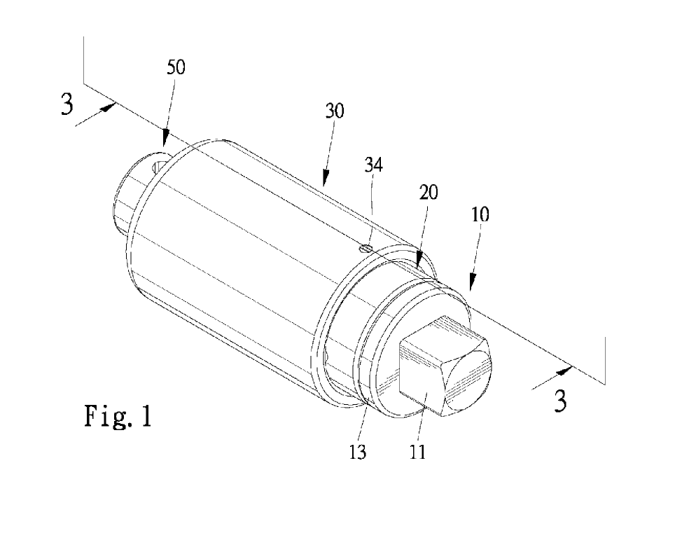

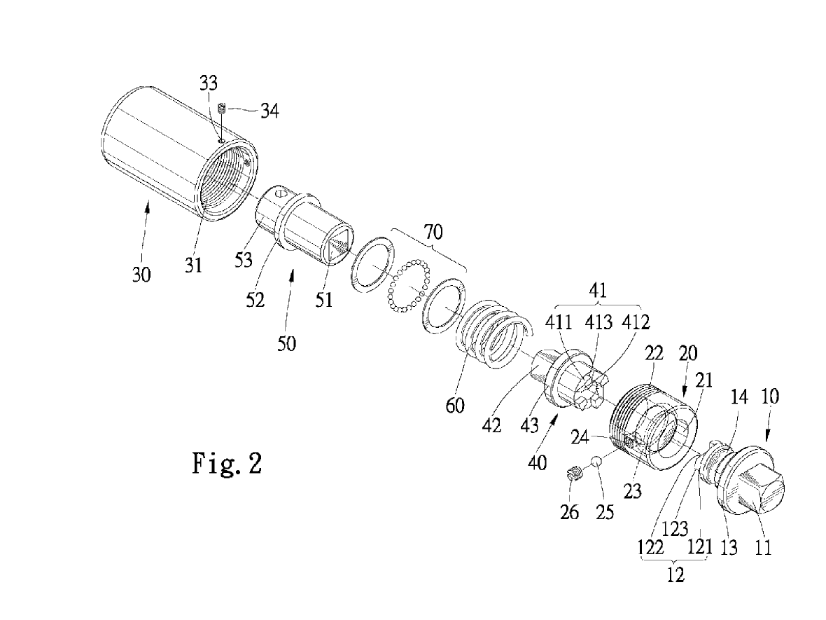

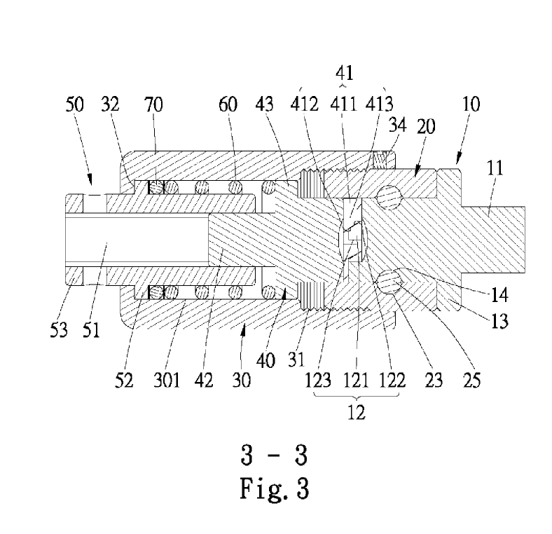

Referring to FIGS. 1 through 6, there is shown a transmission for transmitting torque smaller than an adjustable value according to a first embodiment of the present invention. The transmission includes a first transmitting element 50, a second transmitting element 40, a third transmitting element 10, a first collar 30, a second collar 20, a bearing 70 and an elastic element 60.

The first transmitting element 50 includes a square tunnel 51 defined therein throughout the length, a shoulder 52 formed thereon between a first end 53 and a second end.

The second transmitting element 40 includes a square insert 42 formed at a first end, a group 41 of wedges 411 formed at a second end and a shoulder 43 formed between the first and second ends. Each of the wedges 411 includes an inclined side 412 and an upright side 413.

The square insert 42 is inserted in the square tunnel 51 so that the second transmitting element 40 can be moved but not rotated relative to the first transmitting element 50.

The third transmitting element 10 includes a group 12 of wedges 121 formed at a first end, a square insert 11 formed at a second end, a shoulder 13 formed between the first and second ends and a groove 14 defined between the group 12 and the shoulder 13. Each of the edges 121 includes an inclined side 122 and an upright side 123.

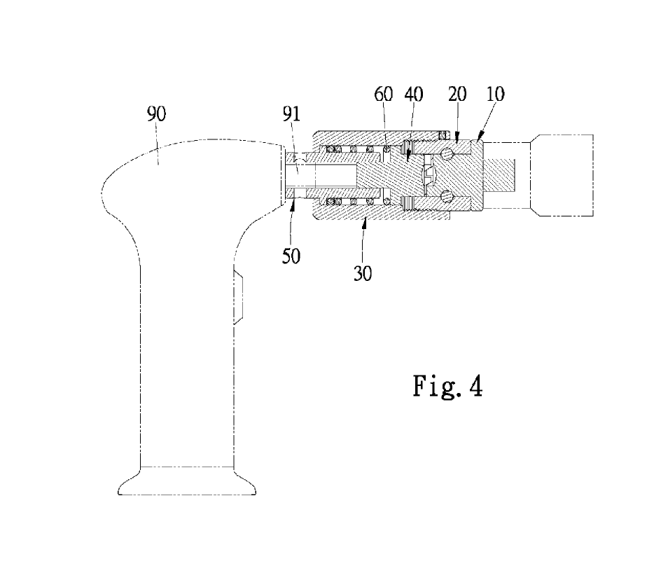

Referring to FIG. 4, a pneumatic tool 90 includes a square axle 91 inserted in the square tunnel 51 so that the pneumatic tool 90 can rotate the first transmitting element 50. The square insert 11 can be inserted in a square cavity defined in a socket. The wedges 411 are engaged with the wedges 121 so that the second transmitting element 40 can rotate the third transmitting element 10.

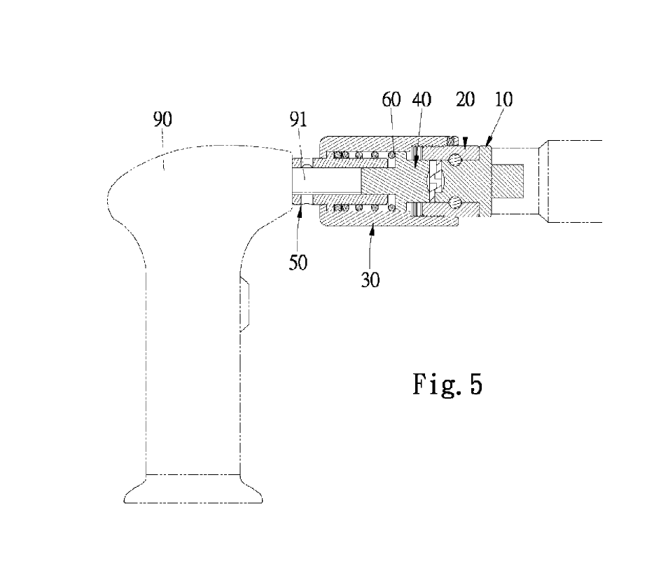

Referring to FIG. 5, after the adjustable value is reached, the wedges 411 are disengaged from the wedges 121 so that the second transmitting element 40 cannot rotate the third transmitting element 10.

The first collar 30 includes a shoulder 32 formed on the interior 301 at a first end, a thread 31 formed on the interior 301 at a second end and a screw hole 33 defined therein in a radial direction. A threaded bolt 34 is driven in the screw hole 33.

The first collar 30 receives the second end of the first transmitting element 50 so that the shoulders 32 and 52 are located against each other.

The second collar 20 includes a tunnel 21 defined therein throughout the length, a thread 22 formed thereon at an end, a groove 23 defined in the interior between the first and second ends and a screw hole 24 defined therein in a radial direction.

The threads 22 and 31 are engaged with each other so that the second collar 20 is connected to the first collar 30. The second collar 20 can be rotated relative to the first collar 30 so that their relative axial position is changed. Thus, the length of the elastic element 60 is changed. That is, the load in the elastic element 60 is changed.

The second collar 20 receives the first end of the third transmitting element 10 so that the grooves 23 and 14 are aligned with each other. Balls 25 are inserted in the grooves 23 and 14 through the screw hole 24. A threaded bolt 26 is driven in the screw hole 24 for retaining the balls 25 within the grooves 23 and 14, thus locking the second collar 20 to the third transmitting element 10.

The elastic element 60 is preferably a helical spring. The elastic element 60 is compressed between the shoulders 52 and 43 so as to push the second transmitting element 40 from the first transmitting element 50 to the third transmitting element 10 and engage the wedges 411 with the wedges 121. The heavier the load is in the elastic element 60, the firmer the wedges 411 are engaged with the wedges 121, and the larger the adjustable value is.

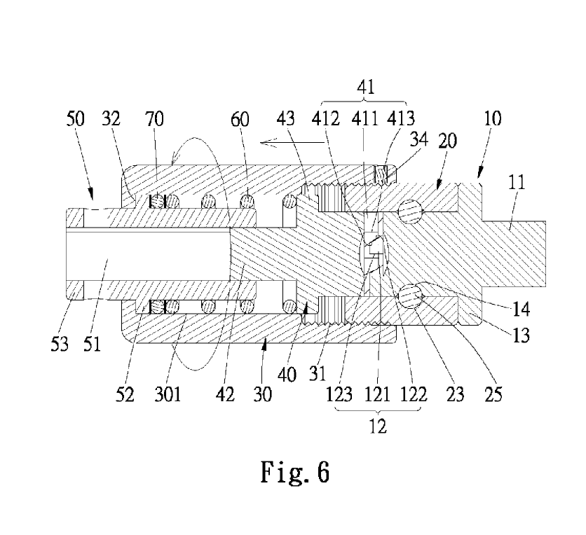

Referring to FIG. 6, the load in the elastic element 60 can be adjusted by adjusting the relative axial position between the first collar 30 and the second collar 20. The relative axial position between the first collar 30 and the second collar 20 can be changed by rotating the first collar 30 relative to the second collar 20.

The bearing 70 is provided between the shoulder 52 and the elastic element 60 for reducing friction when the first collar 30 is rotated relative to the second collar 20.

The threaded bolt 37 can be driven through the screw hole 33 so as to abut the second collar 20 and retain the relative axial position between the first collar 30 and the second collar 20.

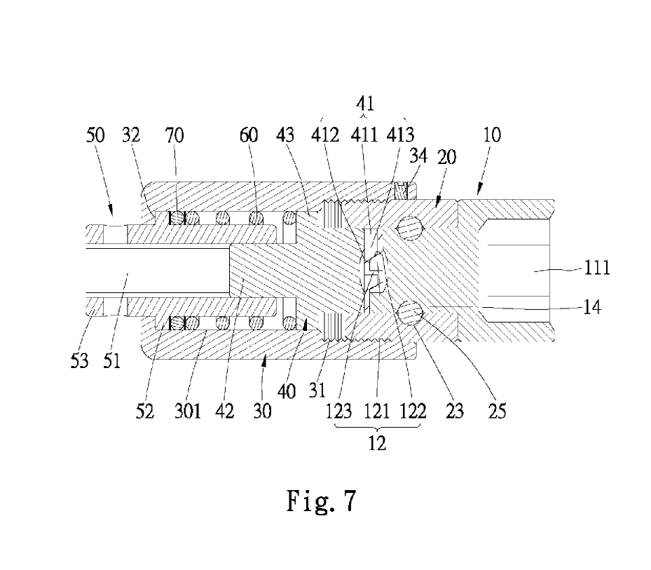

Referring to FIG. 7, there is shown a transmission for transmitting torque smaller than an adjustable value according to a second embodiment of the present invention. The second embodiment is like the first embodiment except that the third transmitting element 10 includes a hexagonal cavity 111 instead of the square insert 11.

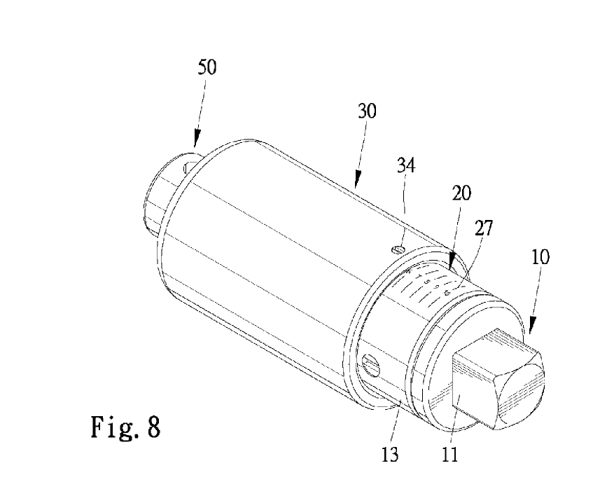

Referring to FIG. 8, there is shown a transmission for transmitting torque smaller than an adjustable value according to a third embodiment of the present invention. The third embodiment is identical to the first embodiment except including a scale 27 provided on the second collar 20 so as to calibrate the maximum torque that the transmission can transmit.

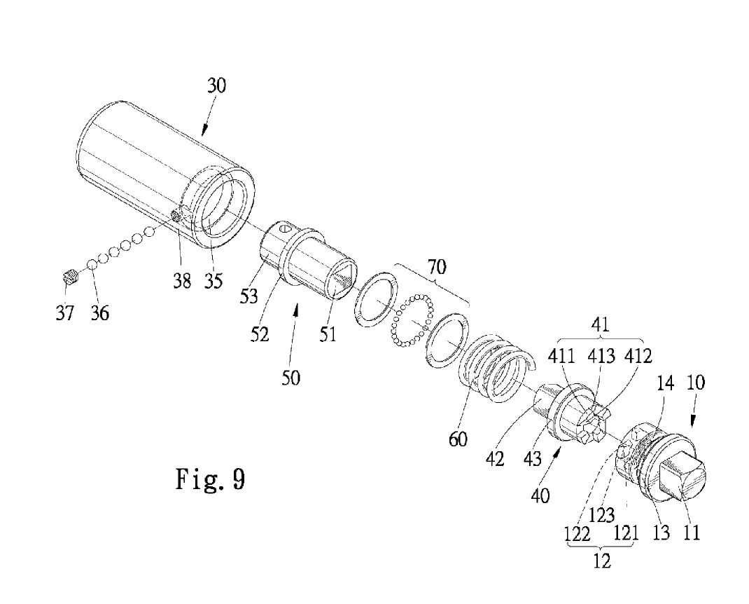

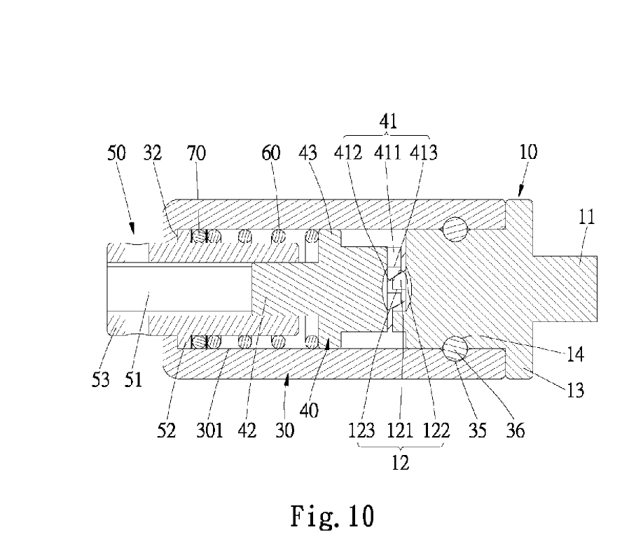

Referring to FIGS. 9 and 10, there is shown a transmission for transmitting torque smaller than a set value according to a fourth embodiment of the present invention. The fourth embodiment is identical to the first embodiment except including a single collar 30′ instead of the first collar 30 and the second collar 20. The collar 30′ includes a groove 35 similar to the groove 23 a screw hole 38 similar to the screw hole 24. Balls 36 can be inserted in the grooves 35 and 14 through the screw hole 38. A threaded bolt 37 is driven in the screw hole 38.

The present invention has been described via the description of the embodiments. Those skilled in the art can derive variations from the embodiments without departing from the scope of the present invention. Therefore, the embodiments shall not limit the scope of the present invention defined in the claims.

What is claimed is:

1. A transmission for transmitting torque smaller than an adjustable value comprising:
a first transmitting element comprising a non-circular tunnel defined throughout the length and a shoulder formed thereon;
a second transmitting element comprising a non-circular insert formed at an end and inserted in the non-circular tunnel, wedges formed at an opposite end and a shoulder formed thereon;
a third transmitting element comprising wedges formed at an end and normally engaged with the wedges of the second transmitting element;
an elastic element compressed between the shoulders of the first and second transmitting elements so as to engage the wedges of the second transmitting element with the wedges of the third transmitting element;
a first collar comprising a thread formed thereon; and
a second collar comprising a thread engaged with the thread of the first collar so that the first and second collars contain the first, second and third transmitting elements and the elastic element and that the first and second collars can be rotated relative to each other to change the relative axial position between them and adjust the adjustable value.

2. The transmission according to claim 1 comprising balls, wherein the third transmitting element defines a groove, wherein the second collar defines a groove in the interior and a hole in communication with the groove thereof, wherein the balls are inserted in the grooves through the hole so as to lock the second collar to the third transmitting element.

3. The transmission according to claim 2 comprising a fastener fit in the hole so as to retain the balls in the grooves.

4. The transmission according to claim 3 wherein the hole is a screw hole, wherein the fastener is a threaded bolt driven in the screw hole.

5. The transmission according to claim 1 wherein the collar comprises a shoulder formed on the interior and located against the shoulder of the first transmitting element.

6. The transmission according to claim 1 wherein each of the wedges of the second transmitting element comprises an inclined side and an upright side.

7. The transmission according to claim 1 wherein each of the wedges of the third transmitting element comprises an inclined side and an upright side.

8. The transmission according to claim 1 wherein the third transmitting element comprises a non-circular insert formed at an opposite end for insertion in a non-circular cavity defined in a socket.

9. The transmission according to claim 1 wherein the third transmitting element comprises a non-circular aperture defined in an opposite end for receiving a fastener.

10. The transmission according to claim 1 comprising a bearing provided between the shoulder of the first transmitting element and the elastic element.

11. A transmission for transmitting torque smaller than a set value comprising:
a first transmitting element comprising a non-circular tunnel defined throughout the length and a shoulder formed thereon;
a second transmitting element comprising a non-circular insert formed at an end and inserted in the non-circular tunnel, wedges formed at an opposite end and a shoulder formed thereon;
a third transmitting element comprising wedges formed at an end and normally engaged with the wedges of the second transmitting element;
an elastic element compressed between the shoulders of the first and second transmitting elements so as to engage the wedges of the second transmitting element with the wedges of the third transmitting element;
a collar for containing the first, second and third transmitting elements and the elastic element.

12. The transmission according to claim 11 comprising balls, wherein the third transmitting element defines a groove, wherein the collar defines a groove in the interior and a hole in communication with the groove thereof, the balls are inserted in the grooves through the hole so as to lock the collar to the third transmitting element.

13. The transmission according to claim 12 comprising a fastener fit in the hole so as to keep the balls in the grooves.

14. The transmission according to claim 13 wherein the hole is a screw hole, wherein the fastener is a threaded bolt driven in the screw hole.

15. The transmission according to claim 11 wherein the collar comprises a shoulder formed on the interior and located against the shoulder of the first transmitting element.

16. The transmission according to claim 11 wherein each of the wedges of the second transmitting element comprises an inclined side and an upright side.

17. The transmission according to claim 11 wherein each of the wedges of the third transmitting element comprises an inclined side and an upright side.

18. The transmission according to claim 11 wherein the third transmitting element comprises a non-circular insert formed at an opposite end for insertion in a non-circular cavity defined in a socket.

19. The transmission according to claim 11 wherein the third transmitting element comprises a non-circular aperture defined in an opposite end for receiving a fastener.

20. The transmission according to claim 11 comprising a bearing provided between the shoulder of the first transmitting element and the elastic element.
